(19) United States
(12) Patent Application Publication
(10) Pub. No.: US 2026/0057652 A1
(43) Pub. Date: Feb. 26, 2026

(54) BIAS DETECTION AND MITIGATION FOR MACHINE LEARNING MODELS

(71) Applicant: NVIDIA Corporation, Santa Clara, CA (US)

(72) Inventors: Kimberly Le Truong, Santa Clara, CA (US); Arun George Zachariah, San Jose, CA (US); Michael Boone, Los Gatos, CA (US); Nikki Delight Pope, Henderson, NV (US)

(21) Appl. No.: 18/813,740

(22) Filed: Aug. 23, 2024

Related U.S. Application Data
(63) Continuation-in-part of application No. 18/811,020, filed on Aug. 21, 2024.

(51) Int. Cl. G06V 10/776

(52) U.S. Cl. CPC G06V 10/776

(57) ABSTRACT

In various examples, bias detection and mitigation for machine learning models is described herein. Systems and methods are disclosed that train or otherwise update one or more machine learning models (e.g., model(s)) using a dataset that includes images of people and annotations indicating skin tones associated with the people as depicted by the images. In some examples, images may be associated with various groups, where each group is associated with a range of lighting values and a range of hue values associated with the skin tones. After an initial training the model(s), the systems and methods may then evaluate the model(s) in order to identify groups for which bias exist and mitigate the bias using further training.

### BACKGROUND

Machine learning models, such as computer vision models, may be used to perform a variety of tasks including people detection, disease diagnosis, and/or the like. However, these machine learning models frequently do not recognize underrepresented minority groups, especially darker skin tones or hues outside of training sets for the machine learning models, which may lead to inaccurate or inequitable outcomes during the application of the machine learning models. As such, some conventional systems may attempt to mitigate biases in models by retrieving and/or generating additional training data that represents groups for which machine learning models tend to show bias. When generating additional training data, these conventional systems may use various techniques, such as generating augmented training data that represents people in different orientations (e.g., rotating and/or flipping people as represented by images).

While these techniques may reduce some types of bias associated with machine learning models, problems still exist. For example, the goals of these conventional systems may be to include the same amount of training data for each group corresponding to a respective skin tone. However, just increasing the amount of training data used to train the machine learning models and/or ensuring that the groups include the same amount of training data usually does not remove all of the bias of the machine learning models. For example, even if a machine learning models is trained using a number of images (e.g., one thousand images) depicting people with a first skin tone and a same number of images (e.g., one thousand images) depicting people with a second, different skin tone, accuracies of the machine learning model when processing additional images may differ greatly between the different skin tones, such that the machine learning model still includes bias because different skin tone groups have different distributions of features and thus those with more feature variation would require more data to be properly represented.

### SUMMARY

Embodiments of the present disclosure relate to bias detection and mitigation for machine learning models. Systems and methods are disclosed that train one or more machine learning models (e.g., model(s)) using a dataset that includes images of people and annotations indicating skin tones associated with the people as depicted by the images. In some examples, images may be associated with various groups, where each group is associated with a range of lighting values and a range of hue values associated with the skin tones. After initially training the model(s), the systems and methods may then evaluate the model(s) in order to identify groups for which bias exist and mitigate the bias using further training. For instance, performance scores associated with the groups may be used to identify the biased groups for which the performance scores do not satisfy at least a threshold performance. The performance scores may then be used to retrieve and/or generate additional training data for the model(s), such that biased groups that are less accurate receive more training data as compared to biased groups that are more accurate. This new training data may then be used to further train or otherwise update the model(s) in order to increase the performance of the model(s) with regard to these biased groups.

In contrast to conventional systems, such as the conventional systems described above, the systems of the present disclosure may use various techniques to evaluate the model(s) after training in order to identify the groups for which bias exists and perform mitigation to remove these biases. This may improve the performance of the model(s) as compared to the conventional systems by causing the model(s) to be more accurate with regard to these groups for which bias usually exists, especially since the systems of the present disclosure identify and/or generate training data based on the accuracies of these groups. For example, to improve the performance of the training, biased groups for which the model(s) is less accurate may receive a greater amount of training data compared to biased groups for which the model(s) is more accurate such that further training of the model(s) is better able to remove and/or reduce all bias.

Additionally, in contrast to the conventional systems, and as described in more detail herein, the systems of the present disclosure may increase the spectrum of skin tones by using additional hue values (e.g., hue angles). For example, the systems of the present disclosure may generate a dataset that includes images for groups that are associated with various lighting value ranges, such as eleven different lighting value ranges (and/or any other number of lighting value ranges), and various hue value ranges, such as six different hue value ranges (and/or any other number of hue value ranges). In some examples, each lighting value range may be associated with each of the hue value ranges in order to maximize the spectrum of skin tones represented by the dataset. For example, if the system(s) uses eleven lighting value ranges and six hue value ranges, then the total number of groups may include sixty-six groups. By increasing the spectrum of skin tones, the systems of the present disclosure may thus increase the performance of the model(s) for certain skin tones as compared to the conventional systems, which may further reduce the bias associated with the model(s).

### BRIEF DESCRIPTION OF THE DRAWINGS

The present systems and methods for bias detection and mitigation for machine learning models are described in detail below with reference to the attached drawing figures, wherein:

FIG. 1 illustrates an example of a process for detecting and mitigating bias in one or more machine learning models, in accordance with some embodiments of the present disclosure;

FIGS. 2A-2B illustrate an example generating one or more datasets associated with one or more models, in accordance with some embodiments of the present disclosure;

FIG. 3 illustrates a data flow diagram illustrating a process for training one or more machine learning models to perform one or more tasks, in accordance with some embodiments of the present disclosure;

FIGS. 4A-4B illustrate an example of evaluating one or more models to detect bias associated with one or more groups, in accordance with some embodiments of the present disclosure;

FIGS. 5A-5B illustrate an example of generating a sampled dataset using images associated with non-biased groups, in accordance with some embodiments of the present disclosure;

FIGS. 6A-6B illustrate an example of generating an augmented dataset associated with biased groups, in accordance with some embodiments of the present disclosure;

FIG. 7 illustrates an example of one or more systems that may be configured to perform at least a portion of the processes described herein, in accordance with some embodiments of the present disclosure;

FIG. 8 illustrates a flow diagram showing a method for detecting and mitigating bias associated with one or more machine learning models, in accordance with some embodiments of the present disclosure;

FIG. 9 illustrates a flow diagram showing a method for generating a new training dataset for one or more biased groups associated with one or more machine learning models, in accordance with some embodiments of the present disclosure;

FIG. 10 illustrates a flow diagram showing a method for mitigating bias in one or more machine learning models, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed related to bias detection and mitigation for machine learning models. For instance, a system(s) may obtain, receive, retrieve, and/or store one or more dataset(s) associated with the model(s). As described herein, the dataset(s) may include at least images depicting people and annotations indicating color attributes, such as skin tones, associated with the people as depicted by the images. In some examples, the skin tones may be associated with lighting values, hue values, and/or tone scores associated with the people as depicted by the images. As described herein, the lighting values may be within a range, such as 0 to 100 (e.g., when using the Monk Color Scale, and/or may include any other range), where 0 represents the darkest lighting and 100 represents the brightest lighting. Additionally, the hue values may also be within a range, such as 0 degrees to 90 degrees (and/or any other range), where 0 degrees represents a red hue and 90 degrees represents a yellow hue. Furthermore, the tone scores may indicate groups that are associated with the lighting values and the hue values, which is described in more detail herein.

The system(s) may perform any type of processing to generate the dataset(s). For instance, in some examples, the system(s) may initially process image data using one or more segmentation techniques (e.g., one or more segmentation models, etc.) in order to generate the images that represent segmented portions (e.g., masks) associated with the people (e.g., at least the faces of the people, at least the skin of the people, and/or any other portion of the people). The system(s) may then use one or more techniques to generate the annotations for the images. For instance, in some examples, the system(s) may process the images using one or more models that are trained to determine the lighting values, the hue values, and/or the tone scores. Additionally, or alternatively, in some examples, the system(s) may use user feedback indicating the lighting values, the hue values, and/or the tone scores. While these are just two example techniques for how the system(s) may determine the skin tones of the people as depicted by the images, in other examples, the system(s) may use additional and/or alternative techniques.

As described herein, the system(s) may associate the images with various groups based on color attributes, such as the lighting values, the hue values, and/or the tone scores. For instance, to generate the groups, the system(s) may use any number of lighting value ranges. For example, if the system(s) uses eleven lighting value ranges, then the lighting value ranges may be based on the Monk Tone Scale and include ranges of 0-14.6, 14.61-21.20, 21.22-30.38, 30.69-42.47, 42.48-55.14, 55.15-77.90, 77.91-87.57, 87.58-92.28, 92.29-93.10, 93.11-94.21, and 94.22-100. Additionally, to generate the groups, the system(s) may use any number of hue value ranges. For example, if the system(s) uses six hue value ranges, then the hue value ranges may be every 15 degrees such as 0-14, 15-29, 30-44, 45-49, 60-74, and 75-90. In some examples, the system(s) may generate groups that associate each of the lighting value ranges with each of the hue value ranges. In some examples, the system(s) may generate one or more groups that associate only a portion of the hue value ranges with one or more of the lighting value ranges.

For example, a first group may include a lighting value range of 0-14.6 and a hue value range of 0-14, a second group may include the lighting value range of 0-14.6 and a hue value range of 15-29, a third group may include the lighting value range of 0-14.6 and a hue value range of 30-44, and/or so forth. This way, the system(s) may increase the overall spectrum of different skin tones that may be represented by the dataset(s), where the dataset(s) is used to train or otherwise update the model(s) and/or mitigate the bias associated with the model(s). However, while these are just a few examples of lighting value ranges and/or hue value ranges that may be used to generate the different groups for the images, in other examples, the system(s) may use any other lighting value ranges and/or hue value ranges to generate the groups.

In some examples, the system(s) may also partition the dataset(s) into additional datasets that are associated with training, validating, and/or evaluating the model(s). For instance, the system(s) may partition the dataset(s) into a first dataset (also referred to, in some examples, as “training dataset”) that is used to train the model(s), partition the dataset(s) into a second dataset (also referred to, in some examples, as “validation dataset”) that is used to validate the model(s), and/or partition the dataset(s) into a third dataset (also referred to, in some examples, as “evaluation dataset”) that is used to evaluate the performance of the model(s). For example, if the dataset(s) includes 100,000 images, then the system(s) may partition the dataset(s) such that the training dataset includes 60,000 images, the validation dataset includes 20,000 images, and the evaluation dataset includes 20,000 images.

In some examples, the system(s) may then use at least the training dataset to train the model(s) to perform one or more tasks. As described herein, the model(s) may be trained to perform any type of task, such as people detection, disease diagnosis, and/or any other type of task for which a model may be trained. Additionally, the model(s) may be trained using any type of technique, such as by updating one or more parameters associated with the model(s) based at least on comparing outputs from the model(s) to ground truth outputs associated with the task for which the model(s) is being trained. In some examples, the technique(s) used to train the model(s) may depend on the type of task for which the model(s) is being trained to perform. For example, the system(s) may use a first training technique to train the model(s) to perform people detection, a second training technique to train the model(s) to perform disease diagnosis, and/or so forth.

During and/or after training the model(s) using the training dataset, the system(s) may use at least the validation dataset (and/or the evaluation dataset) to evaluate the model(s) to detect bias. For instance, the system(s) may apply the images from the validation dataset to the model(s) which may process the images and output data associated with the task for which the model(s) was trained to perform. The system(s) may then determine, based at least on the output data, images that were accurately processed by the model(s) and images that were inaccurately processed by the model(s). Additionally, using the annotations associated with the validation dataset, the system(s) may determine, for one or more groups (e.g., each group), a total number of images associated with the group from the validation dataset, a number of images associated with the group that the model(s) accurately processed, and/or a number of images associated with the group that the model(s) inaccurately processed. The system(s) may then use these determinations to identify groups for which the model(s) includes bias.

For instance, and for a group, the system(s) may determine a performance based at least on the total number of images associated with the group from the validation dataset and the number of images that the model(s) accurately processed. For example, if the total number of images associated with the group is 100 images and the number of images that the model(s) accurately processed is 70 images, then the performance may include an accuracy score of 70%. The system(s) may then perform similar processes to determine one or more performances for one or more (e.g., each) of the other groups. Additionally, the system(s) may determine a threshold performance, such as an average performance, associated with the validation dataset. In some examples, the system(s) may determine the threshold performance based at least on a total of all of the accuracy scores for the groups divided by the total number of groups. The system(s) may then use the performances for the groups and the threshold performance to determine the groups for which the model(s) includes bias, which may be referred to as the “biased groups,” and/or the groups for which the model(s) does not include bias, which may be referred to as the “non-biased groups.”

For instance, the system(s) may determine that groups for which the performances are less than the threshold performance are associated with a bias and the groups for which the performances are equal to or greater than the threshold performance are not associated with bias. For a first example, if a first performance associated with a first group includes an accuracy score of 50% and the threshold performance includes an accuracy score of 90%, then the system(s) may determine that the model(s) includes a bias associated with the first group. For a second example, if a second performance associated with a second group includes an accuracy score of 95% and the threshold performance again includes the accuracy score of 90%, then the system(s) may determine that the model(s) does not includes a bias associated with the second group. The system(s) may then continue to perform similar processes for one or more (e.g., each) of the other groups.

The system(s) may then generate a new dataset to mitigate the bias associated with the model(s) using one or more techniques. For instance, in some examples, the system(s) may use the images that are associated with the non-biased groups and/or weights associated with the non-biased groups to generate the new dataset. For example, the system(s) may determine the accuracy scores associated with the non-biased groups. The system(s) may then determine a total accuracy score associated with all of the non-biased groups (and/or all of the groups), such as by summing the accuracy scores associated with the non-biased groups (and/or all of the groups). For a non-biased group, the system(s) may then determine a weight using the accuracy score associated with the non-biased group and the total accuracy score. For example, the system(s) may determine the weight by dividing the accuracy score by the total accuracy score. The system(s) may then perform similar processes to determine weights associated with one or more (e.g., each) of the other non-biased groups.

The system(s) may then use the weights associated with the non-biased groups to identify images to include in the new dataset. For instance, the system(s) may select more images and/or a greater percentage of images associated with non-biased groups for which the model(s) was more accurate, which may be indicated by higher weights, as compared to non-biased groups for which the model(s) was less accurate, which may be indicated by lower weights. This is because, in some examples, the images associated with the non-biased groups for which the model(s) was more accurate may better train the model(s) as compared to the images associated with the non-biased groups for which the model(s) was less accurate and/or the images associated with the biased groups. As such, by generating the new dataset using such a process, the system(s) may ensure that the new dataset includes the best images for improving the performance of the model(s).

For example, and for a non-biased group, the system(s) may identify the images from at least a portion of the dataset(s) (e.g., the training dataset, the validation dataset, and/or the evaluation dataset) that are associated with the non-biased group. The system(s) may then use the weight associated with the non-biased group to select (e.g., randomly sample) a percentage of the images. In some examples, the system(s) may select a percentage of the images that directly correlates with the weight. For example, if the weight associated with the non-biased group is 0.15 and the total number of images associated with the non-biased group is 100 images, then the system(s) may select 15 of the images to include in the new dataset. The system(s) may then perform similar processes to select additional images to include in the new dataset for one or more (e.g., each) of the other non-biased groups.

The system(s) may then associate the images from the new dataset with the biased groups for which the performance did not satisfy the threshold performance. In some examples, the system(s) may associate more images and/or a greater percentage of images with biased groups for which the model(s) was less accurate as compared to biased groups for which the model(s) was more accurate. This is because, in some examples, the performance of the model(s) may increase more for the biased groups for which more training is performed as compared to biased groups for which less training is performed. As such, biased groups for which the model(s) is less accurate may require a larger number of images for further training in order to increase the performance of the model(s) associated with these biased groups.

For instance, and similar to the non-biased groups, the system(s) may determine weights associated with the biased groups based at least on the accuracy scores associated with the biased groups and a total accuracy score associated with the biased groups (and/or all of the groups). For example, the system(s) may determine the weights based at least on dividing the accuracy scores by the total accuracy score. The system(s) may then use the weights to associate with the images with the biased groups. For instance, in some examples and for a biased group, the system(s) may determine a number of images to associate with the biased group by multiplying a total number of images from the new dataset by an inverse of the weight associated with the biased group. For example, if the total number of images from the new dataset includes 10,000 images and the weight associated with the biased group includes 0.05, then the system(s) may select 9,500 images for that biased group.

The system(s) may then use one or more techniques to generate augmented training data associated with the biased groups. For instance, and for a biased group, the system(s) may process the images associated with the biased group from the new dataset using one or more models (referred to, in some examples, as an “augmentation model(s)”) that are trained to generate the augmented images for the biased group. For example, and for an image of a person, input into the augmentation model(s) may include image data representing the image and data representing the lighting value range and hue value range associated with the biased group. Additionally, the output from the augmentation model(s) may include an augmented image of the person that now includes at least a lighting value that is within the lighting value range and a hue value that is within the hue value range associated with the biased group. The system(s) may then perform similar processes to augmented one or more additional images (e.g., each additional image) associated with the biased group and/or one or more additional biased group (e.g., each additional biased group).

The system(s) may then further train the model(s) using the augmented training data along with annotations indicating the lighting values, the hue values, and/or the tone scores associated with the people as represented by the augmented images. For instance, the system(s) may further train the model(s) using one or more similar processes as the system(s) used to perform the initial training of the model(s). Additionally, after further training the model(s), the system(s) may continue to perform one or more of the processes described herein to determine whether there is bias associated with one or more new groups and/or mitigate the bias associated with the new group(s). For instance, the system(s) may continue to perform these processes until a threshold number of iterations has occurred (e.g., one iteration, two iterations, five iterations, ten iterations, etc.), the model(s) satisfies a threshold performance (e.g., 90%, 95%, 99%, etc.), the model(s) satisfies the threshold performance for one or more (e.g., all) of the groups, and/or any other event occurs.

While the examples herein describe detecting and mitigating biases associated with skin tones of people depicted by images, similar processes may be performed to detect and/or mitigate other types of biases. For example, the system(s) may use similar processes to detect and/or mitigate biases associated with genders, ages, and/or so forth. Additionally, while the examples herein describe detecting and mitigating biases associated with people, in some examples, similar processes may be performed to detect and/or mitigate biases associated with other types of objects. For a first example, if a model is more accurate when processing images of red cars as compared to blue cars, then the system(s) may use similar processes to further train the model such that an accuracy of the model increases when processing images of blue cars. For a second example, if a model is more accurate when processing images of 50 MPH signs as compared to 75 MPH signs, then the system(s) may use similar processes to further train the model such that an accuracy associated the model increases when processing images of 75 MPH signs.

Furthermore, while the examples herein describe performing these processes with regard to models that process image data to perform tasks associated with images, in other examples, similar processes may be used with respect to other types of sensor data. For example, the system(s) may use similar processes to detect and/or mitigate biases associated with models that process LiDAR data, RADAR data, sonar data, audio data, text data, and/or any other type of data.

In some examples, the system(s) and/or the process(es) described herein may be implemented in additional technologies. For instance, the system(s) and/or the process(es) may be implemented into one or more additional systems that train machine learning models to perform various tasks such that the system(s) and/or the process(es) is able to reduce the bias associated with those machine learning models. For a first example, if an additional system is training a machine learning model to detect and/or track objects, the system(s) and/or the process(es) may be implemented within the additional system to reduce the bias associated with the machine learning model. For a second example, if an additional system is training a machine learning model to detect and/or track vehicles located within an environment, the system(s) and/or the process(es) may be implemented within the additional system to again reduce the bias associated with the machine learning model.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

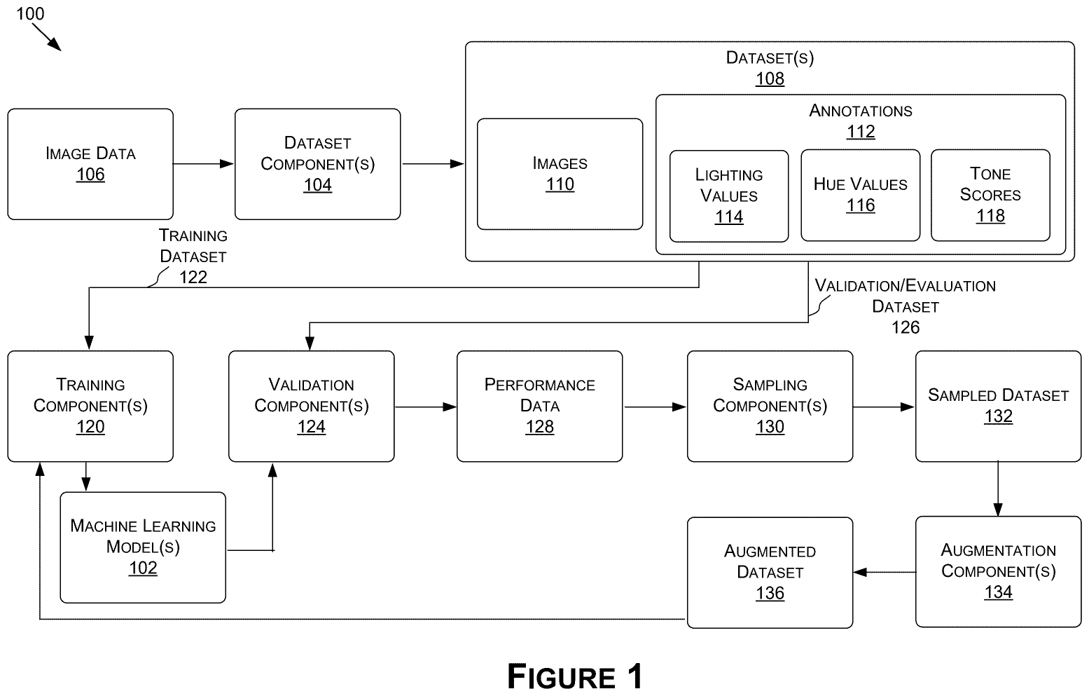

With reference to FIG. 1, FIG. 1 illustrates an example of a process 100 for detecting and mitigating bias in one or more machine learning models 102 (model(s) 102), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more dataset components 104 processing image data 106 representing images in order to generate one or more datasets 108. As described herein, the images may depict people that include various skin tones. As such, in some examples, to generate the dataset(s) 108, the dataset component(s) 104 may segment the images in order to generate cropped images depicting more of the people and less of the backgrounds and/or generate cropped images depicting specific portions of the people, such as faces of the people (and/or other parts of the skin of the people). The images represented by the image data 106 and/or the cropped images may include images 110 of the dataset(s) 108. In some examples, the dataset component(s) 104 may further generate annotations 112 associated with the images 110. As shown, the annotations 112 may include color attributes associated with the skin tones of the people represented by the images 110, such as lighting values 114, hue values 116, and tone scores 118.

The dataset component(s) 104 may further associate the images 110 with various groups based at least on the lighting values 114, the hue values 116, and/or the tone scores 118. For instance, to generate the groups, the dataset component(s) 104 may use any number of lighting value ranges. For example, if the dataset component(s) 104 uses eleven lighting value ranges, then the lighting value ranges may be based on the Monk Color Scale (and/or any other scale) and include ranges of 0-14.6, 14.61-21.20, 21.22-30.38, 30.69-42.47, 42.48-55.14, 55.15-77.90, 77.91-87.57, 87.58-92.28, 92.29-93.10, 93.11-94.21, and 94.22-100. Additionally, to generate the groups, the dataset component(s) 104 may use any number of hue value ranges. For example, if the dataset component(s) 104 uses six hue value ranges, then the hue value ranges may be every 15 degrees such as 0-14, 15-29, 30-44, 45-49, 60-74, and 75-90 degrees. While these are just a couple examples of lighting value ranges and/or hue value ranges that may be used to generate the groups, in other examples, the dataset component(s) 104 may use additional and/or alternative lighting value ranges and/or hue value ranges.

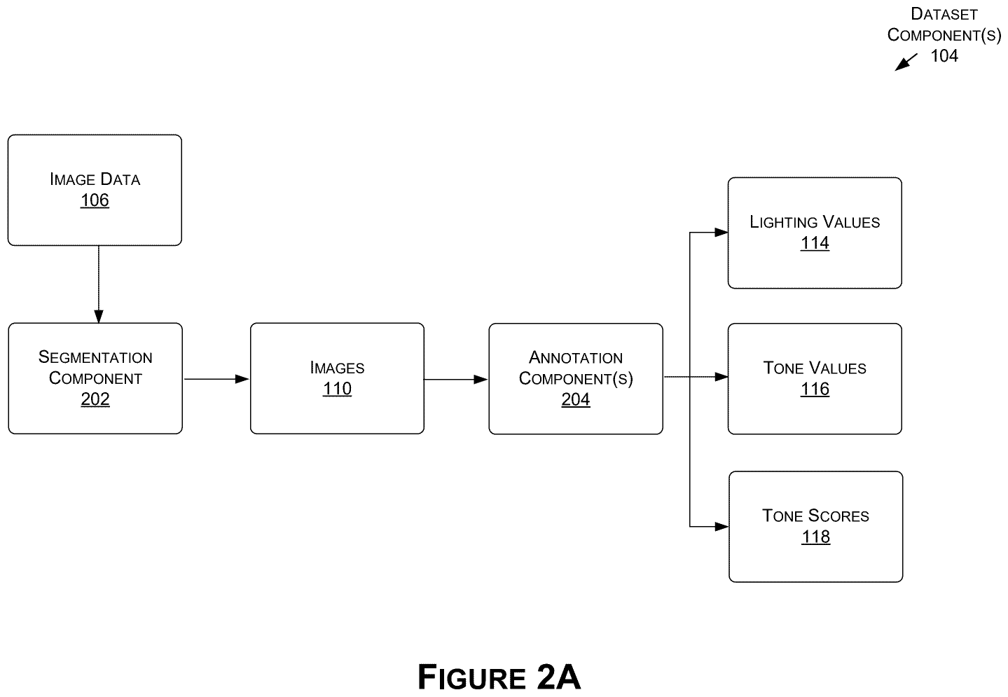

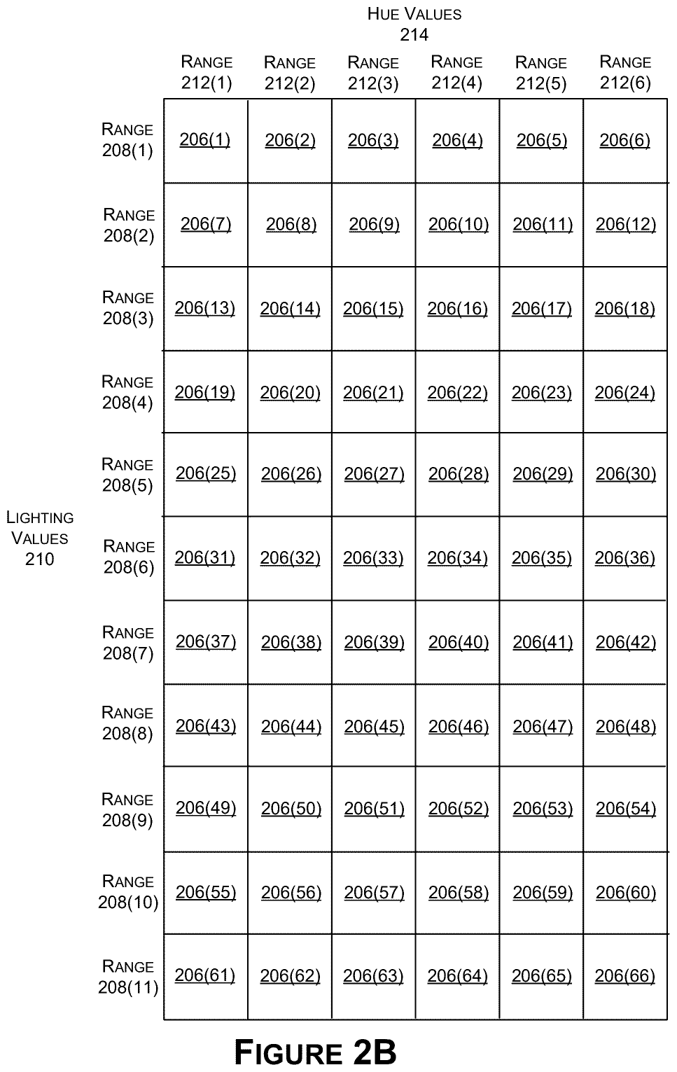

For instance, FIGS. 2A-2B illustrate an example generating one or more datasets associated with one or more models, in accordance with some embodiments of the present disclosure. As shown by the example of FIG. 2A, the dataset component(s) 104 may include one or more segmentation components 202 that are configured to segment at least a portion of the images represented by the image data 106 in order to generate the images 110 (e.g., cropped images). For instance, in some examples, the segmentation component(s) 202 may include and/or use one or more machine learning models, one or more neural networks, one or more algorithms, one or more modules, and/or any other type of processing component that performs object segmentation, classification, and/or image cropping.

The dataset component(s) 104 may further include one or more annotation components 204 that are configured to generate the annotations associated with the images 110. In some examples, the annotation component(s) 204 may include and/or use one or more machine learning models, one or more neural networks, one or more algorithms, one or more modules, and/or any other type of processing component that is configured to automatically generate the annotations. Additionally, or alternatively, in some examples, the annotation component(s) 204 may use other techniques to generate the annotations, such as based on input data from one or more users. In any of the examples, and as described herein, the annotations associated with the images 110 may include, but are not limited to, the lighting values 114, the hue values 116, and/or the tone scores 118.

As illustrated by the example of FIG. 2B, the dataset component(s) 104 may associate the images 110 with various groups 206 (1)-(66) (also referred to singularly as “group 206” or in plural as “groups 206”). As shown, the groups 206 may be associated with ranges 208 (1)-(11) (also referred to singularly as “range 208” or in plural as “ranges 208”) of lighting values 210 (which are or include lighting values 114) and ranges 212 (1)-(6) (also referred to singularly as “range 212” or in plural as “ranges 212”) of hue values 214 (which are or include hue values 116. While the example of FIG. 2B illustrates sixty-six groups 206 that are associated with eleven ranges 208 of the lighting values 210 and six ranges 212 of the hue values 214, in other examples, the images 110 may be associated with any number of groups that are associated with any number of ranges of the lighting values 210 and/or any number of ranges of the hue values 214.

Referring back to the example of FIG. 1, the process 100 may include one or more training components 120 using at least a portion of the dataset(s) 108 to train the model(s) 102 to perform one or more tasks, where the at least the portion of the dataset(s) 108 may include a training dataset 122. As described herein, the model(s) 102 may be trained to perform any type of task, such as people detection, disease diagnosis, and/or any other type of task for which a model may be trained. Additionally, the model(s) 102 may be trained using any type of technique, such as by updating one or more parameters associated with the model(s) 102 based at least on comparing outputs from the model(s) 102 to ground truth outputs. In some examples, the technique used to train the model(s) 102 may depend on the type of task for which the model(s) 102 is being trained to perform. For example, the training component(s) 120 may use a first training technique to train the model(s) 102 to perform people detection, a second training technique to train the model(s) 102 to perform disease diagnosis, and/or so forth.

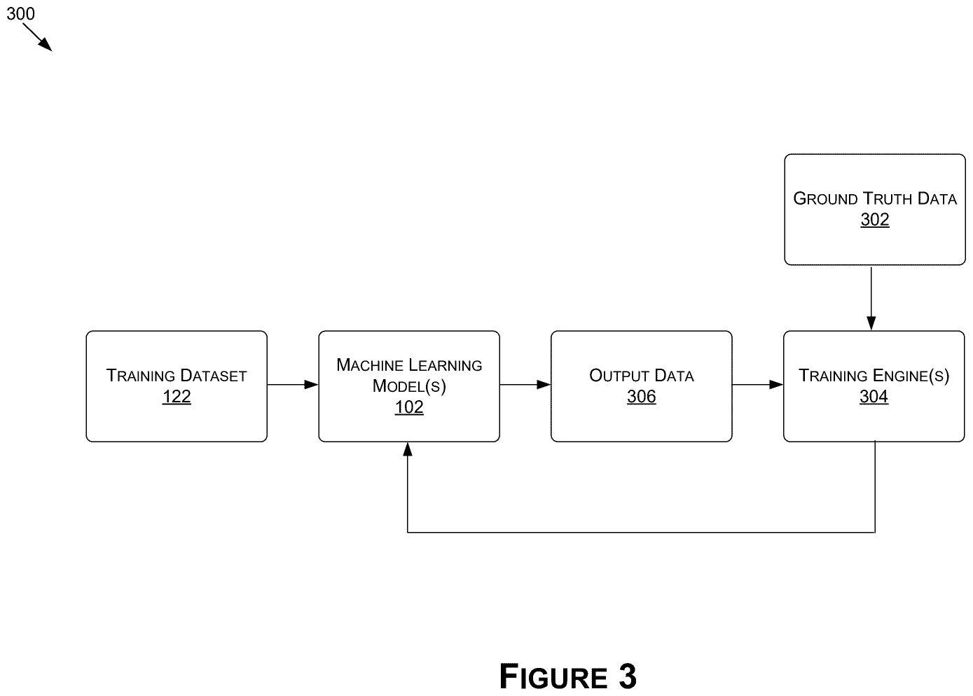

For more detail, FIG. 3 illustrates a data flow diagram illustrating a process 300 for training one or more machine learning models to perform one or more tasks, in accordance with some embodiments of the present disclosure. As shown, the model(s) 102 may be trained using the training dataset 122 as well as corresponding ground truth data 302. In some examples, the ground truth data 302 may correspond to the task(s) for which the model(s) 102 is being trained. For a first example, if the model(s) 102 is being trained to perform people detection, then the ground truth data 302 may represent annotations indicating identifiers of the people that are depicted by the images 110 from the training dataset 122. For a second example, if the model(s) 102 is being trained to perform disease diagnosis, then the ground truth data 302 may represent annotations indicating diseases of the people that are depicted by the images 110 from the training dataset 122.

As described herein, the ground truth data 302 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert), and/or a combination thereof. In some examples, for each image 110 from the training dataset 122, there may be corresponding ground truth data 302.

As further illustrated by the example of FIG. 3, the training component(s) 120 may use one or more training engines 304 that are configured to use one or more loss functions that measure loss (e.g., error) in outputs 306 as compared to the ground truth data 302. Any type of loss function may be used to, such as cross entropy loss, mean squared loss, mean absolute error, mean bias error, and/or any other loss function types. In some examples, different outputs 306 may include different loss functions, where the training engine(s) 304 then combines the loss functions to form a total loss (e.g., using one or more weights). The losses may then be used to train (e.g., update the parameters of) the model(s) 102. In any example, backward pass computations may be performed to recursively compute gradients of the loss function(s) with respect to training parameters. In some examples, weights and/or biases of the model(s) 102 may be used to compute these gradients.

Referring back to the example of FIG. 1, the process 100 may include using one or more validation components 124 to evaluate the model(s) 102 for bias. For instance, the validation component(s) 124 may apply the images 110 associated with one or more validation/evaluation datasets 126 (and/or, in some examples, the training dataset 122, etc.) to the model(s) 102. The model(s) 102 may then process the images 110 and output data associated with the task for which the model(s) 102 was trained to perform. Based at least on the output data and ground truth data, the validation component(s) 124 may determine at least images 110 that were accurately processed by the model(s) 102 and images 110 that were inaccurately processed by the model(s) 102.

Additionally, using the annotations 112 from at least the validation/evaluation dataset 126, the validating component(s) 124 may determine, for one or more groups (e.g., each group), a total number of images 110 associated with the group that the model(s) 102 processed, a number of images 110 that the model(s) 102 accurately processed, and/or a number of images 110 that the model(s) 102 inaccurately processed. The validation component(s) 124 may then use these determinations to identify groups for which the model(s) 102 includes bias. Additionally, the validation component(s) 124 may generate and/or output performance data 128 representing which groups are associated with bias (e.g., biased groups), which groups are not associated with bias (e.g., non-biased groups), and/or performance information (e.g., accuracies) associated with the groups.

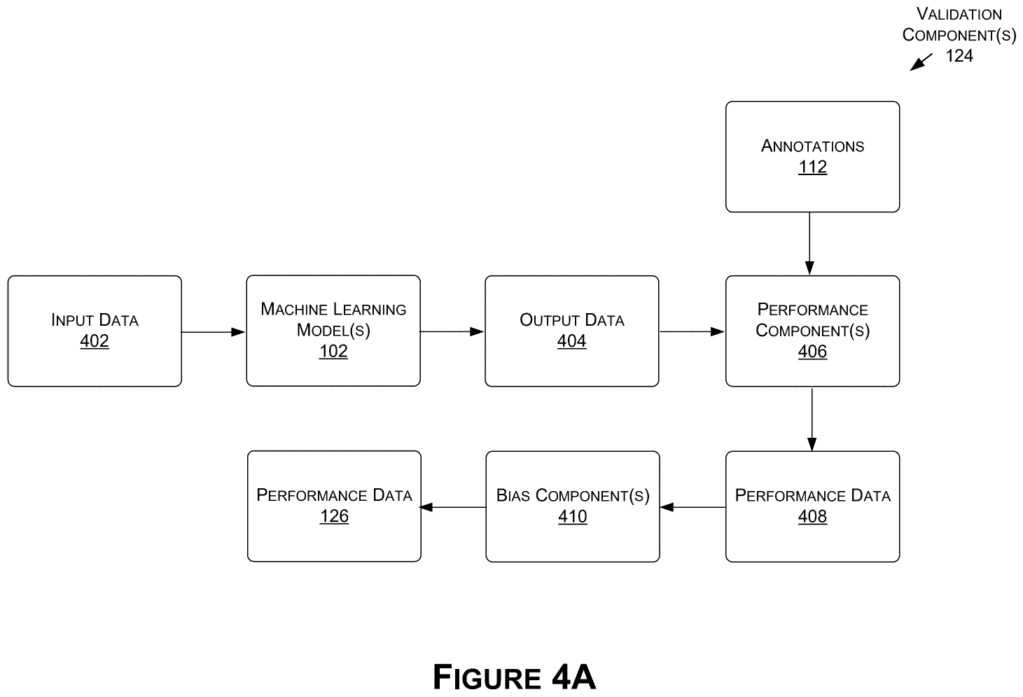

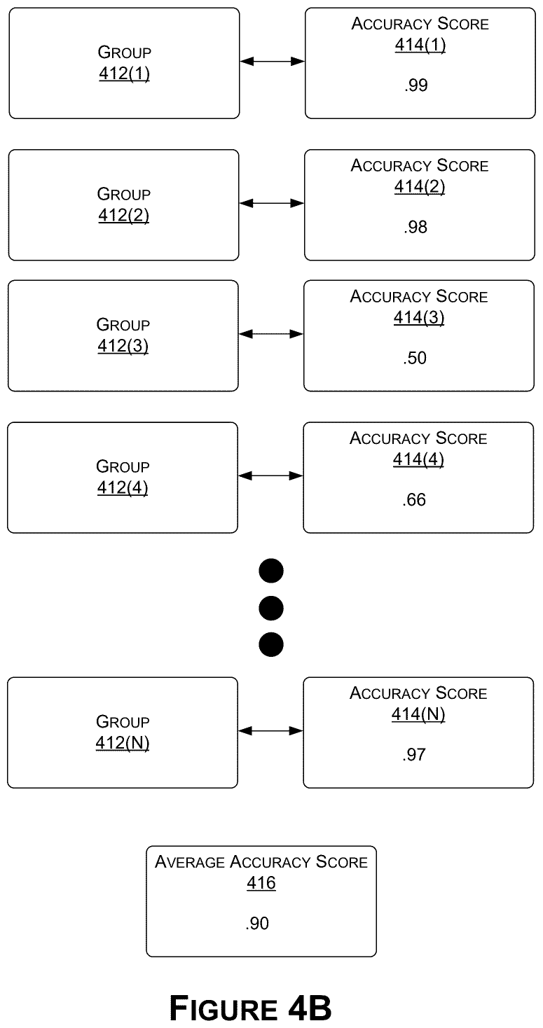

For more details, FIGS. 4A-4B illustrate an example of evaluating one or more models to detect bias associated with one or more groups, in accordance with some embodiments of the present disclosure. As shown by the example of FIG. 4A, the validation component(s) 124 may input, into the model(s) 102, input data 402 representing images of people. In some examples, the input data 402 may include and/or represent the images 110 from the validation/evaluation dataset 126, the training dataset 122, and/or the entire dataset(s) 108. The model(s) 102 may then process the input data 402 and output data 404 associated with the processing. For a first example, if the model(s) 102 is trained to perform people detection, then the output data 404 may represent predicted identifiers associated with the people as depicted by the images 110. For a second example, if the model(s) 102 is trained to perform disease diagnosis, then the output data 404 may represent predicted diseases associated with the people as depicted by the images 110.

The validation component(s) 124 may then use one or more performance components 406 that are configured to analyze the output data 404, ground truth data associated with the input data 402, and the annotations (e.g., the annotations 112) associated with the input data 402 to determine, for the groups, total numbers of images represented by the input data 402, numbers of images that the model(s) 102 accurately processed, and/or numbers of images that the model(s) 102 inaccurately processed. Additionally, the performance component(s) 406 may use these determinations to analyze how the model(s) 102 performed with respect to the different groups.

For instance, and for a group, the performance component(s) 406 may use the total number of images associated with the group and the number of images that the model(s) 102 accurately processed to determine an accuracy score associated with the group. In some examples, the performance component(s) 406 determines the accuracy score by dividing the number of images that the model(s) 102 accurately processed by the total number of images. For example, if the total number of images is 100 images and the number of images that the model(s) 102 accurately processed is 70 images, then the accuracy score may include 70% and/or 0.70. The performance component(s) 406 may then perform similar processes to determine one or more additional accuracy scores associated with one or more additional groups (e.g., each group).

The performance component(s) 406 may further determine a threshold performance associated with the groups, such as by using the individual performances associated with the groups. In some examples, the performance component(s) 406 determines the threshold performance as the average performance among the groups. For example, the performance component(s) 406 may determine the threshold performance by summing the accuracy scores associated with the groups to determine a total accuracy score and then dividing the total accuracy score by a total number of groups. The performance component(s) 406 may then generate and/or output performance data 408 representing the performances (e.g., the accuracy scores) of the groups and the threshold performance (e.g., the average accuracy score).

As further illustrated by the example of FIG. 4A, the validation component(s) 124 may use one or more bias components 410 that are configured to use at least the performance data 408 to detect whether there is bias associated with one or more groups. For instance, and as described herein, the bias component(s) 410 may detect bias associated with a group when a performance of the group is less than the threshold performance or determine that there is no bias associated with the group when the performance of the group is equal to or greater than the threshold performance. The bias component(s) 410 may then generate and/or output the performance data 128 representing which groups are associated with bias (e.g., biased groups), which groups are not associated with bias (e.g., non-biased groups), and/or performances associated with the groups.

For instance, and as illustrated by the example of FIG. 4B, the performance component(s) 406 may process the data associated with groups 412(1)-(N) (also referred to singularly as “group 412” or in plural as “groups 412”) in order to determine accuracy scores 414(1)-(N) (also referred to singularly as “accuracy score 414” or in plural as “accuracy scores 414”) associated with the groups 412. Additionally, the performance component(s) 406 may determine an average accuracy score 416 using the accuracy scores 414. The bias component(s) 410 may then use the accuracy scores 414 and the average accuracy score 416 to detect one or more groups 412 for which bias exists. For example, the bias component(s) 410 may detect bias associated with at least the groups 412(3)-(4) since the accuracy scores 414(3)-(4) are less than the average accuracy score 416.

Referring back to the example of FIG. 1, the process 100 may include one or more sampling components 130 generating a sampled dataset 132 using at least the performance data 128. For instance, and as described herein, the sampling component(s) 130 may identify images 110 that are associated with the non-biased groups, such as images 110 from the training dataset 122, the validation/evaluation dataset 126, and/or the entire dataset(s) 108. The sampling component(s) 130 may then use the performance data 128 to determine weights associated with the non-biased groups. In some examples, the sampling component(s) 130 may use the accuracy scores to determine that non-biased groups that are associated with greater performances include higher weights as compared to non-biased groups that are associated with lower performances. The sampling component(s) 130 may then use the weights associated with the non-biased groups to select portions of the images 110 associated with the non-biased groups to include in the sampled dataset 132.

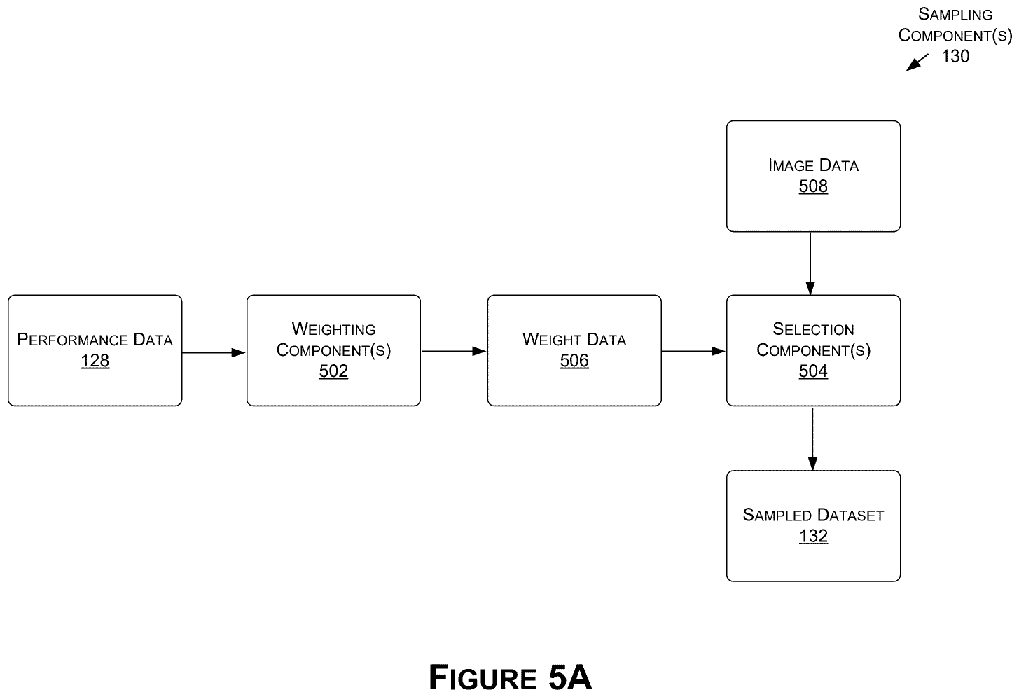

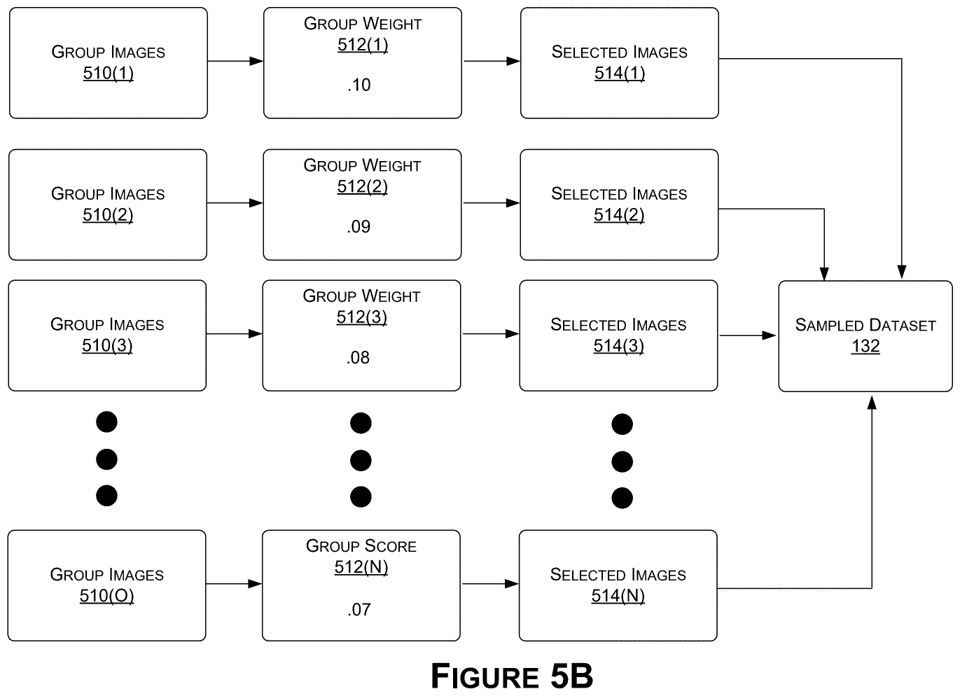

For more details, FIGS. 5A-5B illustrate an example of generating a sampled dataset using images associated with non-biased groups, in accordance with some embodiments of the present disclosure. As shown by the example of FIG. 5A, the sampling component(s) 130 may use one or more weighting components 502 to determine weights associated with the groups using at least a portion of the performance data 128. As described herein, the performance data 128 may represent at least the biased groups, the non-biased groups, and/or the performances (e.g., the accuracy scores) associated with the groups. In some examples, the weighting component(s) 502 may determine the weights associated with the groups based at least on respective performances associated with the individual groups and a total performance associated with all of the groups. For example, the weighting component(s) 502 may determine a total accuracy score by summing the individual accuracy scores associated with the groups (e.g., all of the groups). The weighting component(s) 502 may then determine, for a group, a weight by dividing the accuracy score associated with the group by the total accuracy score. Additionally, the weighting component(s) 502 may perform similar processes for one or more additional groups (e.g., each group).

The sampling component(s) 130 may then use one or more selection components 504 to select images to include in the sampled dataset 132 based at least on weight data 506 representing the weights associated with the groups and image data 508. In some examples, the image data 508 may represent the images 110 from the training dataset 122, the validation/evaluation dataset 126, and/or the entire dataset(s) 108. As described herein, to select the new training images 110, the selection component(s) 130 may randomly sample images 110 that are associated with the non-biased groups using the weights associated with the non-biased groups. For example, and for a non-biased group, if the non-biased group is associated with 100 images and the weight associated with the non-biased group is 0.20, then the selection component(s) 130 may randomly select 20 images from the 100 images to include as part of the sampled dataset 132. The selection component(s) 504 may then perform similar processes to select images 110 associated with one or more additional non-biased groups (e.g., each non-biased group).

For instance, and as illustrated by the example of FIG. 5B, the selection component(s) 504 may retrieve images 510(1)-(O) associated with non-biased groups. Additionally, the selection component(s) 504 may determine weights 512(1)-(O) associated with the non-biased groups, such as by using the weight data 506. The selection component(s) 504 may then use the weights 512(1)-(O) to select images to include in the sampled dataset 132. For example, and as shown, the selection component(s) 504 may use the first weight 512(1) to select first images 514(1), such as by randomly selecting 10% of the first images 510(1), use the second weight 512(2) to select second images 514(2), such as by randomly selecting 9% of the second images 510(2), use the third weight 512(3) to select third images 514(3), such as by randomly selecting 8% of the third images 510(3), and use the final weight 512(O) to select final images 514(O), such as by randomly selecting 7% of the final images 510(O). The selection component(s) 504 may then add the selected images 514(1)-(O) to the sampled dataset 132.

Referring back to the example of FIG. 1, the process 100 may include one or more augmentation components 134 using the sampled dataset 132 in order to generate an augmented dataset 136 representing augmented images. For instance, the augmentation component(s) 134 may initially select images 110 included in the sampled dataset 132 to associate with the biased groups. As described herein, in some examples, the augmentation component(s) 134 may use the weights associated with the biased groups to select the images 110. For instance, and for a biased group, the augmentation component(s) 134 may use the weight to randomly select a number of images 110 from the sampled dataset 132. In some examples, the number of images selected is determined based at least on an inverse of the weight. For example, if the number of images included in the sampled dataset 132 includes 1,000 images and the weight associated with the biased group includes. 10, then the augmentation component(s) 134 may select 900 of the images. The augmentation component(s) 134 may then perform similar processes for one or more additional biased groups (e.g., each biased group).

Additionally, the augmentation component(s) 134 may augment the images 110 in order to generate augmented images associated with the biased groups, where the augmented images may be included in an augmented dataset 136. As described herein, in some examples, the augmentation component(s) 134 may use one or more augmentation models that are trained to generate the augmented images for the biased groups. For example, and for an image of a person that is being augmented for a biased group, input into the augmentation model(s) may include image data representing the image and data representing the lighting value range and hue value range associated with the biased group. Additionally, the output from the augmentation model(s) may include an augmented image of the person that now includes a lighting value that is within the lighting value range and a hue value that is within the hue value range associated with the biased group. The augmentation component(s) 134 may then perform similar processes to augmented one or more additional images 110 (e.g., each additional image 110) associated with the biased group and/or one or more additional biased group (e.g., each biased group).

In some examples, the augmentation component(s) 134 may further perform one or more processes to augmented one or more features associated with the people as depicted by the augmented images. For instance, the augmentation component(s) 134 (e.g., the augmentation model(s)) may update locations, orientations, and/or structures of noses, cheeks, lips, chins, eyes, eyebrows, hair, facial hair, and/or any other feature associated with people and as depicted by the augmented images.

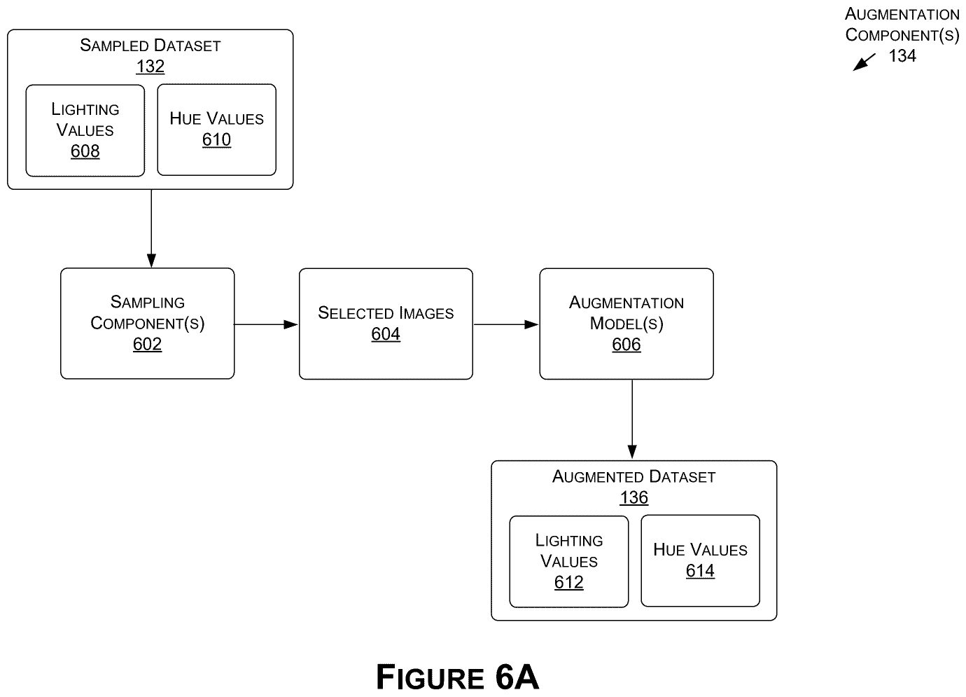

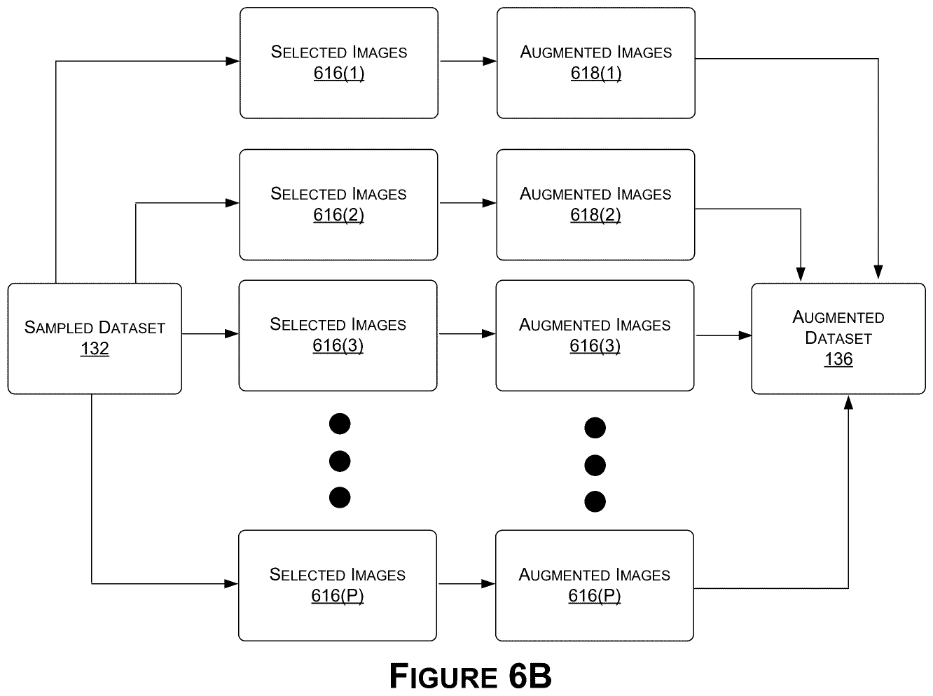

For instance, FIGS. 6A-6B illustrate an example of generating an augmented dataset associated with biased groups, in accordance with some embodiments of the present disclosure. As shown by the example of FIG. 6A, the augmentation component(s) 134 may use a sampling component(s) 602 to randomly sample the images from the sampled dataset 132 in order to select images 604 to associated with the biased groups. In some examples, and as described herein, the sampling component(s) 602 may use the inverse of the weights associated with the biased groups to select the images. For example, the sampling component(s) 602 may select a first number of images 604 from the sampled dataset 132 to associated with a first biased group based on an inverse of a first weight associated with the first biased group, a second number of images 604 to associate with a second biased group based on an inverse of a second weight associated with the second biased group, and/or so forth.

The augmentation component(s) 134 may then use one or more augmentation models 606 to augment the selected images 604. As described herein, the augmentation model(s) 606 may be trained to augment the selected images 604 by at least changing lighting values and/or hue values associated with the people as depicted by the selected images 604. For instance, and as shown, the images associated with the sampled dataset 132 may initially be associated with lighting values 608 and hue values 610. However, by performing the augmentation processes described herein, the augmented images included in the augmented dataset 136 may be associated with new lighting values 612 and/or new hue values 614 such that the augmented images are now associated with the biased groups.

As shown by the example of FIG. 6B, the weights associated with the biased groups may be used to select images 616(1)-(O) for further training the model(s) 102. For instance, a first weight associated with a first biased group may be used to select first images 616(1) associated with the first biased group, a second weight associated with a second biased group may be used to select second images 616(2) associated with the second biased group, a third weight associated with a third biased group may be used to select third images 616(3) associated with the third biased group, and/or so forth until a final weight associated with a final biased group is used to selected final images 616 (P) associated with the final biased group. The augmentation model(s) 606 may then augment the first images 616(1) to generate first augmented images 618(1) that are associated with the lighting value range and hue value range associated with the first biased group, augment the second images 616(2) to generate second augmented images 618(2) that are associated with the lighting value range and hue value range associated with the second biased group, augment the third images 616(3) to generate third augmented images 618(3) that are associated with the lighting value range and hue value range associated with the third biased group, and augment the final images 616 (P) to generate final augmented images 618 (P) that are associated with the lighting value range and hue value range associated with the final biased group. The augmentation model(s) 606 may also augment other features associated with people (e.g., cheeks, lips, chines, eyes, eyebrows, hair, facial hair, etc.). This may include dynamically adjusting the spatial positioning, angles, and shapes of these features to enhance or modify their appearance. These augmented images 616(1)-(P) may then be added to the augmented dataset 136.

Referring back to the example of FIG. 1, the process 100 may further include the training component(s) 120 further training the model(s) 102 using the augmented dataset 136. By further training the model(s) 102 using the augmented dataset 136, the training component(s) 120 may attempt to remove the bias that the model(s) 102 originally had with regard to the biased groups. As described herein, in some examples, the training component(s) 120 may use any technique to further train the model(s) 102, such as the technique illustrated with regard to the example of FIG. 3. Additionally, after each iteration of training, the process 100 may continue to repeat such that the validation component(s) 124 detects one or more new biased groups, the sampling component(s) 130 generates one or more new sampled datasets 132, and the augmentation component(s) 134 generates one or more new augmented datasets 136 for further training the model(s) 102. In some examples, the process 100 may continue to repeat until the occurrence of one or more events. For example, the process 100 may continue to repeat until a threshold number of iterations has occurred (e.g., one iteration, two iterations, five iterations, ten iterations, etc.), the model(s) 102 satisfies a threshold performance (e.g., 90%, 95%, 99%, etc.), the model(s) satisfies the threshold performance for one or more (e.g., all) of the groups, and/or any other event occurs.

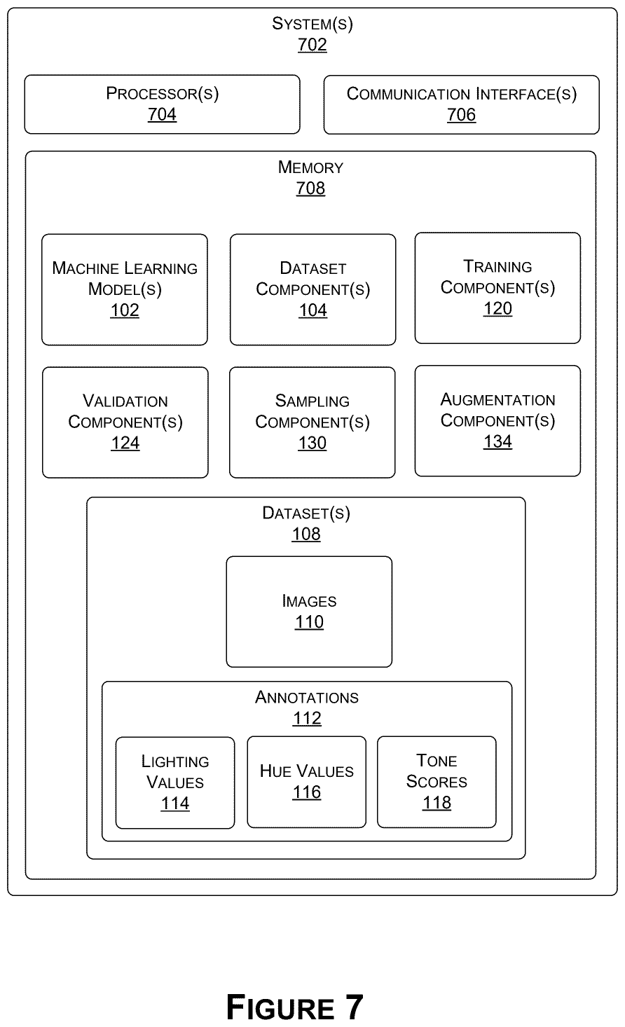

In some examples, the process 100 may be performed by one or more computing devices, one or more systems, one or more servers, and/or the like. For instance, FIG. 7 illustrates an example of one or more systems 702 that may be configured to perform at least a portion of the processes described herein, in accordance with some embodiments of the present disclosure. As shown, the system(s) 702 (which may be similar to, and/or include, an example computing device 1100 and/or an example data center 1200) may include at least one or more processors 704 (which may be similar to, and/or include, a CPU(s) 1106 and/or a GPU(s) 208), one or more network interfaces 706 (which may be similar to, and/or include, a communication interface(s) 1110), and memory 708 (which may be similar to, and/or include, a memory 1104).

As shown, the memory 708 may store at least the model(s) 102, the dataset component(s) 104, the training component(s) 120, the validation component(s) 124, the sampling component(s) 130, the augmentation component(s) 134, and/or the dataset(s) 108. Additionally, the processor(s) 704 may be configured to execute the model(s) 102, the dataset component(s) 104, the training component(s) 120, the validation component(s) 124, the sampling component(s) 130, and/or the augmentation component(s) 134 to perform one or more of the processes described herein. While the example of FIG. 7 illustrates each of the components as including software stored in the memory 708, in other examples, a component may include hardware, a module, code, a device, a program, an application, and/or any other type of processing component.

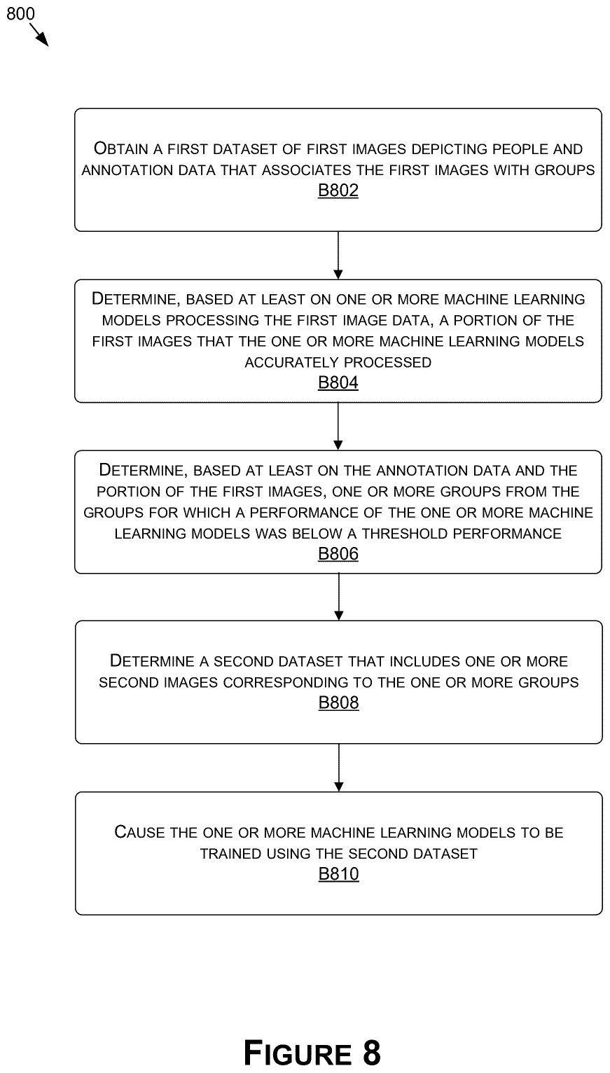

Now referring to FIG. 8-10, each block of methods 800, 900, and 1000, described herein, comprises a computing process that may be performed using any combination of hardware, firmware, and/or software. For instance, various functions may be carried out by a processor executing instructions stored in memory. The methods 800, 900, and 1000 may also be embodied as computer-usable instructions stored on computer storage media. The methods 800, 900, and 1000 may be provided by a standalone application, a service or hosted service (standalone or in combination with another hosted service), or a plug-in to another product, to name a few. In addition, the methods 800, 900, and 1000 are described, by way of example, with respect to t FIG. 1. However, these methods 800, 900, and 1000 may additionally or alternatively be executed by any one system, or any combination of systems, including, but not limited to, those described herein.

FIG. 8 illustrates a flow diagram showing a method 800 for detecting and mitigating bias associated with one or more machine learning models, in accordance with some embodiments of the present disclosure. The method 800, at block B802, may include obtaining a first dataset of first images depicting people and annotation data that associates the first images with groups. For instance, the validation component(s) 124 may receive at least the validation/evaluation dataset 126 that includes the images 110 depicting the people and the annotations 112 indicating the lighting values 114, the hue values 116, and/or the tone scores 118 associated with the people as represented by the images 110. As described herein, the annotations 112 may be used to associate with the images 110 with groups, such as groups that are associated with various lighting value ranges and/or various hue value ranges.

The method 800, at block B804, may include determining, based at least on one or more machine learning models processing the first images, a portion of the first images that the one or more machine learning models accurately processed. For instance, the validation component(s) 124 may process the images 110 using the model(s) 102. Based at least on the processing, the validation component(s) 124 may determine at least the portion of the images 110 that the model(s) 102 accurately processed. For example, if the model(s) 102 is trained to perform people detection, the validation component(s) 124 may determine the portion of the images 110 for which the model(s) 102 correctly identified the person.

The method 800, at block B806, may include determining, based at least on the annotation data and the portion of the first images, one or more groups from the groups for which a performance of the one or more machine learning models was below a threshold performance. For instance, the validation component(s) 124 may determine the biased group(s) for which the performance of the model(s) was below the threshold performance. In some examples, to determine the biased group(s), the validation component(s) 124 may use the annotations 112 and the portion of the images 110 to determine accuracy scores associated with the groups. The validation component(s) 124 may then determine an average accuracy score for the groups using the accuracy scores. Additionally, the validation component(s) 124 may determine the biased group(s) as being associated with one or more accuracy scores that are less than the threshold accuracy score.

The method 800, at block B808, may include determining a second dataset that includes one or more second images corresponding to the one or more groups. For instance, the sampling component(s) 130 may perform one or more of the processes described herein to generate the sampled dataset 132. For instance, in some examples, the sampled dataset 132 may include images 110 associated with one or more non-biased groups from the training dataset 122, the validation/evaluation dataset 126, and/or the entire dataset(s) 108. The augmentation component(s) 134 may then perform one or more of the processes described herein to select one or more images 110 from the sampled dataset 132 to associate with the biased group(s). Additionally, the augmentation component(s) 134 may then perform one or more augmentation techniques to augment the selected image(s) 110 in order to generate one or more augmented images to include in the augmented dataset 136.

The method 800, at block B810, may include causing the one or more machine learning models to be trained using at least the second dataset. For instance, the training component(s) 120 may use the augmented dataset 136 to further train the model(s) 102. In some examples, by performing the processes described herein, the further training of the model(s) 102 may improve the performance of the model(s) 102 when processing data associated with the biased group(s). Additionally, to further improve the performance of the model(s) 102, these processes may continue to repeat for one or more additional iterations.

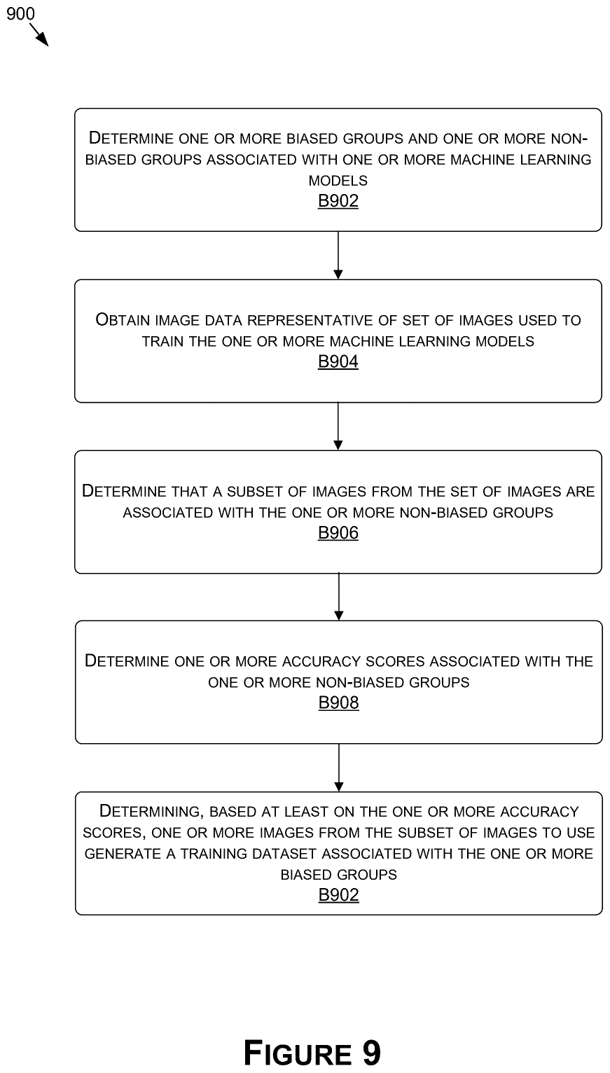

FIG. 9 illustrates a flow diagram showing a method 900 for generating a new training dataset for one or more biased groups associated with one or more machine learning models, in accordance with some embodiments of the present disclosure. The method 900, at block B902, may include determining one or more biased groups and one or more non-biased groups associated with one or more machine learning models. For instance, the validation component(s) 124 may determine the biased group(s) and the non-biased group(s) associated with the model(s) 102. As described herein, in some examples, the validation component(s) 124 may determine the biased group(s) and the non-biased group(s) based at least on performances associated with the groups. For example, the biased group(s) may be associated with one or more performances that do not satisfy a threshold performance while the non-biased group(s) may be associated with one or more performances that satisfy the threshold performance.

The method 900, at block B904, may include obtaining image data representative of a set of images used to train the one or more machine learning models and the method 900, at block B906, may include determining that a subset of the images from the set of images are associated with the one or more non-biased groups. For instance, the sampling component(s) 130 may obtain at least a portion of the dataset(s) 108 used to train the model(s) 102, such as the training dataset 122 and/or the validation/evaluation dataset 126. The sampling component(s) 130 may then determine the images 110 from the at least the portion of the dataset(s) 108 that are associated with the non-biased group(s). For example, the sampling component(s) 130 may determine the images that are associated with one or more combinations of lighting values 114 and hue values 116 that are within one or more combinations of lighting value ranges and hue value ranges associated with the non-biased group(s).

The method 900, at block B908, may include determining one or more accuracy scores associated with the one or more non-biased groups. For instance, the validation component(s) 124 may initially determine the accuracy scores associated with the groups. As described herein, the accuracy scores may be determined based on total numbers of the images 110 associated with the groups and numbers of images for which the model(s) 102 accurately processed. The sampling component(s) 130 may then use the performance data 128 representing the accuracy scores to determine the accuracy score(s) that is associated with the non-biased group(s).

The method 900, at block B910, may include determining, based at least on the one or more accuracy scores, one or more images from the subset of images to use to generate a training dataset for the one or more biased groups. For instance, the sampling component(s) 130 may use the accuracy score(s) and the subset of images 110 associated with the non-biased group(s) to generate the sampled dataset 132. As described herein, in some examples, the sampling component(s) 130 may select the image(s) to include in the sampled dataset 132 based at least on one or more weights associated with the non-biased group(s) such that a greater percentage of images 110 associated with a non-biased group that includes a greater accuracy score is selected as compared to a non-biased group that includes a lower accuracy score.

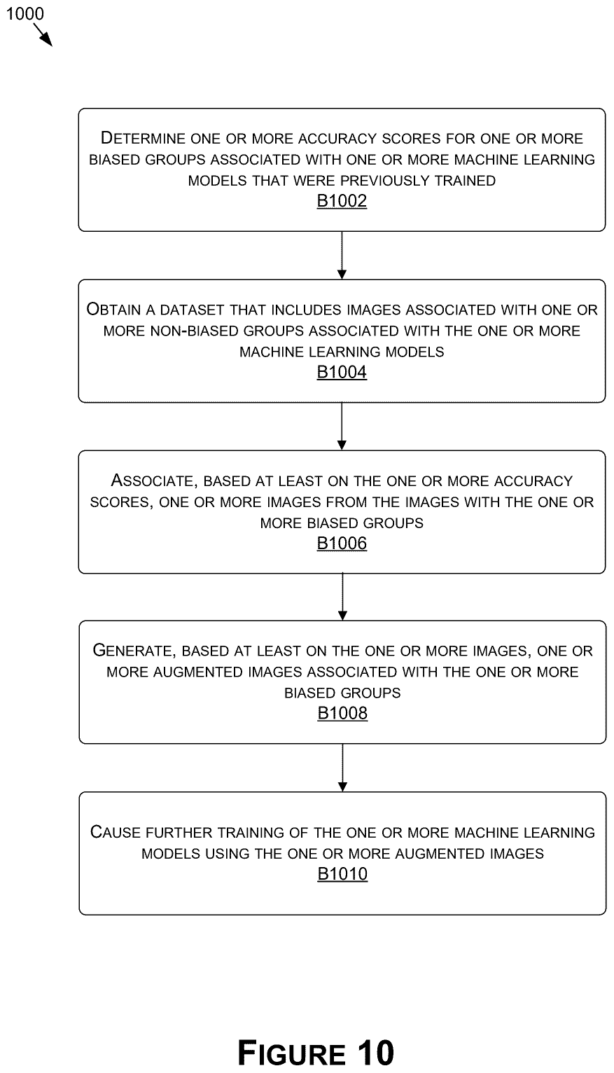

FIG. 10 illustrates a flow diagram showing a method 1000 for mitigating bias in one or more machine learning models, in accordance with some embodiments of the present disclosure. The method 1000, at block B1002, may include determining one or more accuracy scores for one or more biased groups associated with one or more machine learning models that were previously trained. For instance, the validation component(s) 124 may initially determine the accuracy scores associated with the groups. As described herein, the accuracy scores may be determined based on total numbers of the images 110 associated with the groups and numbers of images for which the model(s) 102 accurately processed. The sampling component(s) 130 may then use the performance data 128 representing the accuracy scores to determine the accuracy score(s) that is associated with the biased group(s).

The method 1000, at block B1004, may include obtaining a dataset that includes images associated with one or more non-biased groups associated with the one or more machine learning models. For instance, the sampling component(s) 130 may generate the sampled dataset 132 that includes the images 110 associated with the non-biased group, such as by using the method 900 of FIG. 9. As described herein, in some examples, the sampling component(s) 130 may select the images to include in the sampled dataset 132 based at least on one or more weights associated with the non-biased group(s) such that a greater percentage of images 110 associated with a non-biased group that includes a greater accuracy score is selected as compared to a non-biased group that includes a lower accuracy score.

The method 1000, at block B1006, may include associating, based at least on the one or more accuracy scores, one or more images from the images with the one or more biased groups. For instance, the augmentation component(s) 134 may associate the image(s) with the biased group(s) based at least on the accuracy score(s). As described herein, the augmentation component(s) 134 may select the image(s) 110 to associate with the biased group(s) based at least on one or more weights associated with the biased group(s) such that a greater percentage of the image(s) is associated with a biased group that includes a lower accuracy score as compared to a biased group that includes a greater accuracy score.

The method 1000, at block B1008, may include generating, based at least on the one or more images, one or more augmented images associated with the one or more biased groups. For instance, the augmentation components) 134 may then generate the augmented dataset 136 that includes the augmented image(s) using the image(s) associated with the biased group(s). As described herein, the augmentation component(s) 134 may use one or more augmentation models to generate the augmented image(s). Additionally, the augmentation image(s) may represent one or more people that are associated with one or more lighting values and one or more hue values that are within one or more lighting value ranges and one or more hue value ranges associated with the biased group(s).

The method 1000, at block B1010, may include causing further training of the one or more machine learning models using the one or more augmented images. For instance, the training component(s) 120 may use the augmented dataset 136 to further train the model(s) 102. In some examples, by performing the processes described herein, the further training of the model(s) 102 may improve the performance of the model(s) 102 when processing data associated with the biased group(s), such as by removing bias associated with the model(s) 102.

### Example Computing Device

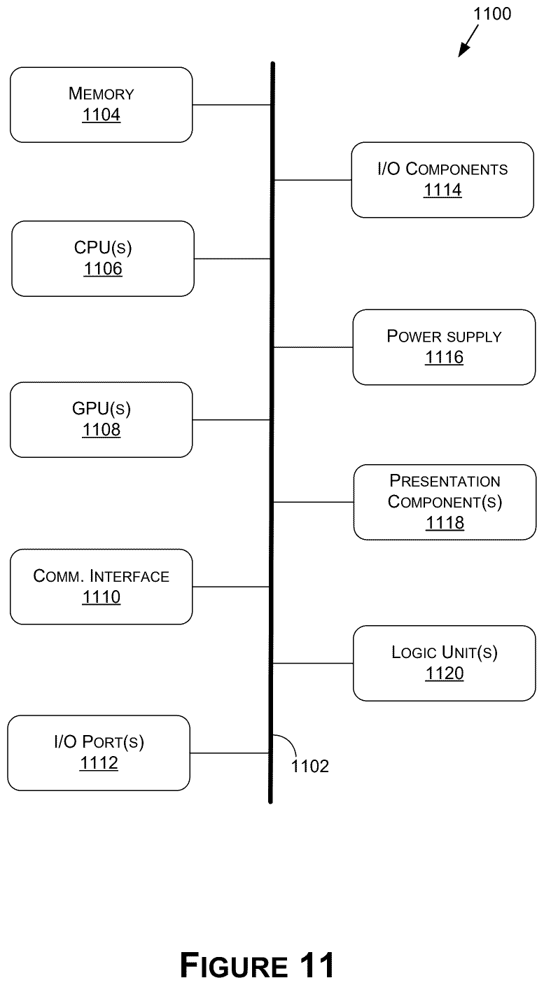

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

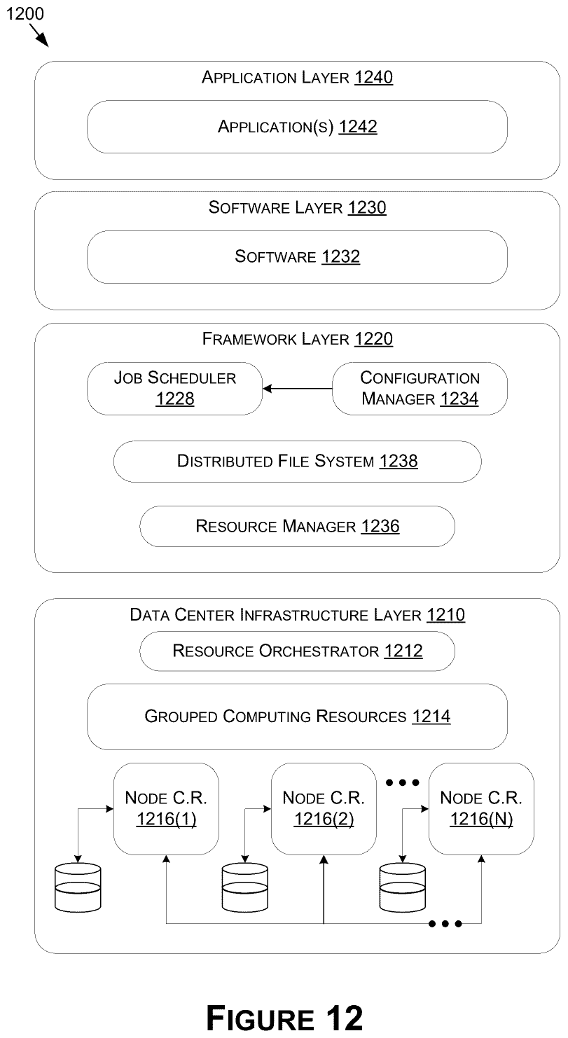

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: associating, based at least on annotation data representative of lighting values and hue values of people as depicted by first images from a first dataset, the first images with groups; determining, based at least on one or more machine learning models processing the first dataset, a portion of the first images that the one or more machine learning models accurately processed; determining, based at least on the portion of the first images, one or more groups from the groups for which one or more performances of the one or more machine learning models are below a threshold performance; and causing the one or more machine learning models to be updated based at least on a second dataset that includes one or more second images associated with the one or more groups.
B: The method of paragraph A, wherein: the groups are associated with lighting value ranges and hue value ranges; and the associating the first images with the groups comprises: determining, based at least on the annotation data, a respective lighting value of the lighting values and a respective hue value of the hue values associated with an individual image of the first images; and associating the individual image with a group of the groups based at least on the respective lighting value being within a lighting value range associated with the group and the respective hue value being within a hue value range associated with the group.
C: The method of either paragraph A or paragraph B, wherein the determining the one or more groups for which the one or more performances of the one or more machine learning models are below the threshold performance comprises: determining, based at least on the portion of the first images, accuracy scores associated with the groups; determining, based at least on the accuracy scores, a threshold accuracy score associated with the groups; and determining that the one or more groups are associated with one or more accuracy scores, from the accuracy scores, that are less than the threshold accuracy score.
D: The method of any one of paragraphs A-C, further comprising: obtaining a third dataset that includes third images used to update the one or more machine learning models; determining, based at least on the portion of the first images, one or more second groups for which one or more second performances of the one or more machine learning models are equal or greater than the threshold performance; and determining the second dataset as including the one or more second images, from the third images, that are associated with the one or more second groups.
E: The method of paragraph D, further comprising: determining one or more accuracy scores associated with the one or more second groups; and determining one or more weights based at least on the one or more accuracy scores, wherein the determining the second dataset is further based at least on the one or more weights.
F: The method of any one of paragraphs A-E, further comprising: determining one or more accuracy scores associated with the one or more groups; and assigning, based at least on the one or more accuracy scores, the one or more second images to the one or more groups, wherein the causing the one or more machine learning models to be updated is based at least on the one or more second images as assigned to the one or more groups.
G: The method of paragraph F, further comprising: determining, based at least on the one or more accuracy scores, one or more weights associated with the one or more groups, wherein the assigning the one or more second images to the one or more groups is based at least on the one or more weights.
H: The method of any one of paragraphs A-G, wherein: the one or more second images are associated with one or more first lighting values and one or more first hue values; the method further comprising generating, based at least on the one or more second images, an augmented dataset that includes one or more augmented images, the one or more augmented images being associated with one or more second lighting values and one or more second hue values corresponding to the one or more groups; and the causing the one or more machine learning models to be updated is based at least on the augmented dataset.
I: A system comprising: one or more processors to: obtain output data associated with one or more machine learning models processing a first dataset including first images associated with groups; determine, based at least on the output data, one or more first groups from the groups for which one or more first performances of the one or more machine learning models are below a threshold performance and one or more second groups from the groups for which one or more second performances of the one or more machine learning models are equal to or greater than the threshold performance; determine, based at least on the one or more second groups, a second dataset that includes one or more second images; and generate, based at least on the one or more second images, an augmented dataset for updating the one or more machine learning modes, the augmented dataset including one or more augmented images associated with the one or more first groups.
J: The system of paragraph I, wherein: the one or more second images are associated with one or more first values of a first color attribute and one or more first values of a second color attribute corresponding to one or more subjects as depicted by the one or more second images; and the generation of the augmented dataset comprises: determining one or more value ranges of the first color attribute and one or more value ranges of the second color attribute associated with the one or more first groups; and generating the one or more augmenting images by at least augmenting the one or more second images such that the one or more subjects depicted by the one or more second images correspond to one or more second values of the first color attribute that are within the one or more value ranges of the first color attribute and one or more second values of the second color attribute that are within the one or more value ranges of the second color attribute.
K: The system of either paragraph I or paragraph J, wherein the one or more processors are further to: update, using a third dataset that includes third images, the one or more machine learning models during a first updating process, where the second dataset includes a portion of the third dataset; and update, using the augmented dataset, the one or more machine learning models during a second updating process.
L: The system of any one of paragraphs I-K, wherein the determination of the one or more first groups for which the one or more first performances are less than the threshold performance and the one or more second groups for which the one or more second performances are equal to or greater than the threshold performance comprises: determining, based at least the output data, one or more first accuracy scores associated with the one or more first groups and one or more second accuracy scores associated with the one or more second groups; determining, based at least on the one or more first accuracy scores and the one or more second accuracy scores, a threshold accuracy score associated with the groups; determining that the one or more first accuracy scores are less than the threshold accuracy score; and determining the one or more second accuracy scores are equal to or greater than the threshold accuracy score.
M: The system of any one of paragraphs I-L, wherein the determination of the second dataset comprises: obtaining a third dataset that includes third images used to update the one or more machine learning models; and determining the second dataset as including the one or more second images, from the third images, that are associated with the one or more second group.
N: The system of any one of paragraphs I-M, wherein the one or more processors are further to: determine one or more accuracy scores associated with the one or more second groups; and determine one or more weights based at least on the one or more accuracy scores, wherein the determination of the second dataset is based at least on the one or more weights associated with the one or more second groups.
O: The system of any one of paragraphs I-N, wherein the one or more processors are further to: determine one or more accuracy scores associated with the one or more first groups; and assign, based at least on the one or more accuracy scores, the one or more second images to the one or more first groups.
P: The system of paragraph O, wherein the one or more processors are further to: determine, based at least on the one or more accuracy scores, one or more weights associated with the one or more first groups, wherein the one or more second images are assigned to the one or more first groups based at least on the one or more weights.
Q: The system of any one of paragraphs I-P, wherein: the groups are associated with value ranges of the first color attribute and value ranges of the second color attribute; and the first images are associated with the groups by: determining, based at least on annotation data associated with the first dataset, a respective value of the first color attribute and a respective value of the second color attribute associated with an individual image of the first images; and associating the individual image with a group of the groups based at least on the respective value of the first color attribute being within a value range of the first color attribute associated with the group and the respective value of the second color attribute being within a value range of the second color attribute associated with the group.
R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
S: One or more processors comprising: processing circuitry to: determine, from a dataset used to update one or more machine learning models, one or more images associated with one or more first groups that include one or more first performance scores associated with the one or more machine learning models; generate, based at least on the one or more images, one or more augmented images associated with one or more second groups that include one or more second performance scores associated with the one or more machine learning models, the one or more second performance scores being less than the one or more first performance scores; and causing an update of the one or more machine learning models using the one or more augmented images.
T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
associating, based at least on annotation data representative of lighting values and hue values of people as depicted by first images from a first dataset, the first images with groups;
determining, based at least on one or more machine learning models processing the first dataset, a portion of the first images that the one or more machine learning models accurately processed;
determining, based at least on the portion of the first images, one or more groups from the groups for which one or more performances of the one or more machine learning models are below a threshold performance; and
causing the one or more machine learning models to be updated based at least on a second dataset that includes one or more second images associated with the one or more groups.

2. The method of claim 1, wherein:
the groups are associated with lighting value ranges and hue value ranges; and
the associating the first images with the groups comprises:
determining, based at least on the annotation data, a respective lighting value of the lighting values and a respective hue value of the hue values associated with an individual image of the first images; and
associating the individual image with a group of the groups based at least on the respective lighting value being within a lighting value range associated with the group and the respective hue value being within a hue value range associated with the group.

3. The method of claim 1, wherein the determining the one or more groups for which the one or more performances of the one or more machine learning models are below the threshold performance comprises:
determining, based at least on the portion of the first images, accuracy scores associated with the groups;
determining, based at least on the accuracy scores, a threshold accuracy score associated with the groups; and
determining that the one or more groups are associated with one or more accuracy scores, from the accuracy scores, that are less than the threshold accuracy score.

4. The method of claim 1, further comprising:
obtaining a third dataset that includes third images used to update the one or more machine learning models;
determining, based at least on the portion of the first images, one or more second groups for which one or more second performances of the one or more machine learning models are equal or greater than the threshold performance; and
determining the second dataset as including the one or more second images, from the third images, that are associated with the one or more second groups.

5. The method of claim 4, further comprising:
determining one or more accuracy scores associated with the one or more second groups; and
determining one or more weights based at least on the one or more accuracy scores,
wherein the determining the second dataset is further based at least on the one or more weights.

6. The method of claim 1, further comprising:
determining one or more accuracy scores associated with the one or more groups; and
assigning, based at least on the one or more accuracy scores, the one or more second images to the one or more groups,
wherein the causing the one or more machine learning models to be updated is based at least on the one or more second images as assigned to the one or more groups.

7. The method of claim 6, further comprising:
determining, based at least on the one or more accuracy scores, one or more weights associated with the one or more groups,
wherein the assigning the one or more second images to the one or more groups is based at least on the one or more weights.

8. The method of claim 1, wherein:
the one or more second images are associated with one or more first lighting values and one or more first hue values;
the method further comprising generating, based at least on the one or more second images, an augmented dataset that includes one or more augmented images, the one or more augmented images being associated with one or more second lighting values and one or more second hue values corresponding to the one or more groups; and
the causing the one or more machine learning models to be updated is based at least on the augmented dataset.

9. A system comprising:
one or more processors to:
obtain output data associated with one or more machine learning models processing a first dataset including first images associated with groups;
determine, based at least on the output data, one or more first groups from the groups for which one or more first performances of the one or more machine learning models are below a threshold performance and one or more second groups from the groups for which one or more second performances of the one or more machine learning models are equal to or greater than the threshold performance;
determine, based at least on the one or more second groups, a second dataset that includes one or more second images; and
generate, based at least on the one or more second images, an augmented dataset for updating the one or more machine learning modes, the augmented dataset including one or more augmented images associated with the one or more first groups.

10. The system of claim 9, wherein:
the one or more second images are associated with one or more first values of a first color attribute and one or more first values of a second color attribute corresponding to one or more subjects as depicted by the one or more second images; and
the generation of the augmented dataset comprises:
determining one or more value ranges of the first color attribute and one or more value ranges of the second color attribute associated with the one or more first groups; and
generating the one or more augmenting images by at least augmenting the one or more second images such that the one or more subjects depicted by the one or more second images correspond to one or more second values of the first color attribute that are within the one or more value ranges of the first color attribute and one or more second values of the second color attribute that are within the one or more value ranges of the second color attribute.

11. The system of claim 9, wherein the one or more processors are further to:
update, using a third dataset that includes third images, the one or more machine learning models during a first updating process, where the second dataset includes a portion of the third dataset; and
update, using the augmented dataset, the one or more machine learning models during a second updating process.

12. The system of claim 9, wherein the determination of the one or more first groups for which the one or more first performances are less than the threshold performance and the one or more second groups for which the one or more second performances are equal to or greater than the threshold performance comprises:
determining, based at least the output data, one or more first accuracy scores associated with the one or more first groups and one or more second accuracy scores associated with the one or more second groups;
determining, based at least on the one or more first accuracy scores and the one or more second accuracy scores, a threshold accuracy score associated with the groups;
determining that the one or more first accuracy scores are less than the threshold accuracy score; and
determining the one or more second accuracy scores are equal to or greater than the threshold accuracy score.

13. The system of claim 9, wherein the determination of the second dataset comprises:
obtaining a third dataset that includes third images used to update the one or more machine learning models; and
determining the second dataset as including the one or more second images, from the third images, that are associated with the one or more second group.

14. The system of claim 9, wherein the one or more processors are further to:
determine one or more accuracy scores associated with the one or more second groups; and
determine one or more weights based at least on the one or more accuracy scores,
wherein the determination of the second dataset is based at least on the one or more weights associated with the one or more second groups.

15. The system of claim 9, wherein the one or more processors are further to:
determine one or more accuracy scores associated with the one or more first groups; and
assign, based at least on the one or more accuracy scores, the one or more second images to the one or more first groups.

16. The system of claim 15, wherein the one or more processors are further to:
determine, based at least on the one or more accuracy scores, one or more weights associated with the one or more first groups,
wherein the one or more second images are assigned to the one or more first groups based at least on the one or more weights.

17. The system of claim 9, wherein:
the groups are associated with value ranges of the first color attribute and value ranges of the second color attribute; and
the first images are associated with the groups by:
determining, based at least on annotation data associated with the first dataset, a respective value of the first color attribute and a respective value of the second color attribute associated with an individual image of the first images; and
associating the individual image with a group of the groups based at least on the respective value of the first color attribute being within a value range of the first color attribute associated with the group and the respective value of the second color attribute being within a value range of the second color attribute associated with the group.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to:
determine, from a dataset used to update one or more machine learning models, one or more images associated with one or more first groups that include one or more first performance scores associated with the one or more machine learning models;
generate, based at least on the one or more images, one or more augmented images associated with one or more second groups that include one or more second performance scores associated with the one or more machine learning models, the one or more second performance scores being less than the one or more first performance scores; and
causing an update of the one or more machine learning models using the one or more augmented images.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center, or
a system implemented at least partially using cloud computing resources.
